(19) United States
(12) Patent Application Publication
(10) Pub. No.: US 2015/0213954 A1
(43) Pub. Date: Jul. 30, 2015

(54) Capacitor and a Method for Producing a Capacitor

(71) Applicant: SIEMENS AKTIENGESELLSCHAFT, München (DE)

(72) Inventors: Richard Matz, Bruckmuhl (DE); Steffen Walter, Oberpframmern (DE)

(21) Appl. No.: 14/430,301

(22) PCT Filed: Jul. 18, 2013
(86) PCT No.: PCT/EP2013/065194

§ 371 Date: Mar. 23, 2015

(30) Foreign Application Priority Data
Sep. 24, 2012 (DE) 10 2012 217 168.1

(51) Int. Cl. H01G 4/28; H01G 4/30

(52) U.S. Cl. CPC H01G 4/28; H01G 4/30

(57) ABSTRACT

The embodiments to a method for producing a capacitor, (e.g., a cylindrical capacitor). The method includes: a) providing a main body; b) producing a layer system on the main body, the layer system including at least two electrically conductive layers each layer galvanically separated from the other layer by at least one dielectric layer, the at least one dielectric layer being produced from at least one green film; and c) sintering the layer system. The invention further relates to a capacitor, (e.g., a cylindrical capacitor), including a layer system that has at least two electrically conductive layers each layer galvanically separated from the other layer by at least one dielectric layer made from at least one sintered green film.

### CROSS-REFERENCE TO RELATED APPLICATIONS

The present patent document is a §371 nationalization of PCT Application Serial Number PCT/EP2013/065194, filed Jul. 18, 2013, designating the United States, which is hereby incorporated by reference, and this patent document also claims the benefit of DE 10 2012 217 168.1, filed on Sep. 24, 2012, which is also hereby incorporated by reference.

### TECHNICAL FIELD

The embodiments relate to a method for producing a capacitor. The embodiments furthermore relate to a capacitor and to the use of such a capacitor for producing a power cable, a coaxial cable, and/or a resonant heating line.

### BACKGROUND

Applications in power electronics increasingly require passive components that may be operated at high voltages, currents, and temperatures, (e.g., at 10 kV, 100 A, and 500° C.). In particular, there is a need for capacitive components that have a charge capacitance up into the μF range and may be used under such extreme operating conditions.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the present embodiments to provide a method for producing a capacitor that may be configured as easily as possible to operation at high voltages, currents, and temperatures, and has an easily settable charge capacitance. It is a further object of the embodiments to provide a corresponding capacitor that may be configured as easily as possible to extreme operating conditions. It is a further object of the embodiments to specify a use of such a capacitor.

A first aspect relates to a method for producing a capacitor, including the acts of: a) providing a main body; b) producing a layer system on the main body, the layer system including at least two electrically conductive layers in each case galvanically isolated from one another by at least one dielectric layer, the at least one dielectric layer being produced from at least one green sheet, and c) sintering the layer system. In other words, a capacitor is produced by producing two or more electrically conductive layers that act as electrodes in the finished capacitor. One or more green sheets are arranged between, in each case, two electrically conductive layers and act as dielectric and isolate the electrically conductive layers from one another. In this respect, a green sheet is understood to refer to an unsintered (“green”) ceramic and/or glass sheet. By way of example, the green sheet may be produced by sheet casting a ceramic material and/or a sinterable glass material on a carrier. The carrier is then removed, as a result of which the unsintered green sheet is obtained. The embodiments are not limited to the use of green sheets produced in this way, however, and therefore it is also possible for green sheets produced in a different way to be used. It may be provided that a green sheet or an electrically conductive layer is applied to the main body as the first layer of the layer system. It may similarly be provided that a green sheet or an electrically conductive layer is produced as the last layer, e.g., as the top layer of the layer system. The total number of layers of the layer system may be selected here as required. By way of example, the layer system may include 3, 4, 5, 6, 7, 8, 9, 10, 11, 12, 13, 14, 15, 16, 17, 18, 19, 20 or more layers, wherein each electrically conductive and/or dielectric layer for its part may be made up of a plurality of layers of the same material or differing materials. After the layer system has been produced, it is sintered, as a result of which the high-temperature-stable capacitor is obtained. In this case, the sintering temperature depends on the materials used and, by way of example, may lie at temperatures of between approximately 800° C. and approximately 1000° C. for green sheets made of what are termed low temperature cofired ceramics (LTCC) or at temperatures of between approximately 1500° C. and approximately 1800° C. for green sheets made of what are termed high temperature cofired ceramics (HTCC) or glass materials. The capacitance of the capacitor produced may be configured particularly easily to the respective intended use thereof by varying the layer system and is determined by the number and total surface area of the electrically conductive layers, by the number and thickness of the dielectric layers and by the permittivity of the dielectric layer(s) after the sintering. The thickness of the dielectric layer(s) additionally determines the electrical breakdown voltage of the capacitor and therefore represents a parameter that may be used to set the balance between capacitance and dielectric strength of the capacitor. The suitable selection of the materials and geometrical dimensions used makes it possible to achieve a high variability in terms of the capacitance and breakdown voltage of the capacitor. With the aid of the method, it is therefore possible to produce capacitors with high charge capacitances up into the μF range that have high temperature resistance and dielectric strength and are therefore also suitable for extreme operating conditions. Moreover, the geometry of the capacitor may be set particularly easily by way of the geometry of the main body and the geometry (geometries) of the green sheet(s), as a result of which the capacitor may be configured particularly easily to different intended uses and may be integrated easily in an extremely wide variety of components.

In one advantageous configuration, it is provided that at least one dielectric layer is produced from at least two plies of the at least one green sheet and/or that the at least one green sheet is wound at least once around the main body to produce at least one dielectric layer. This represents a possibility for setting the capacitance of the capacitor in a targeted manner by way of the thickness of the dielectric, (e.g., the thickness of the dielectric green sheet(s)), specifically by the number of plies and/or windings. The thickness of the dielectric additionally determines the electrical breakdown voltage of the capacitor. By way of example, it may be provided that one, a plurality of or all dielectric layers each consist of 1, 2, 3, 4, 5, 6, 7, 8, 9, 10, 11, 12, 13, 14, 15 or more plies and/or windings of one or more green sheets.

Further advantages arise if an organic paste containing metal particles is used to produce the electrically conductive layers. This represents a particularly fast and flexible possibility for producing the electrically conductive layers. The organic binder proportion may be burnt out during the sintering of the layer system, as a result of which the metal particles form a conductive sintered assembly for the electrodes. Elements such as, for example, silver and/or metal alloys may be used as metal particles.

In a further advantageous configuration, it is provided that the electrically conductive layers are produced with the aid of a dipping process and/or a spraying process. This, too, makes it possible to produce the electrically conductive layers in a particularly fast and flexible manner.

Since the main body is removed from the layer system before the layer system is sintered, it is possible in a further configuration to produce a recess or a cavity in the capacitor. This makes it possible for the capacitor to be integrated particularly easily into appropriately shaped components. Moreover, it is thereby possible to dispense with the use of high-temperature-resistant or sinterable main bodies and to reuse the main body for a renewed method run.

If use is made of a cylindrical main body, the dielectric layers may be produced particularly easily by winding. The finished capacitor is then in the form of a cylindrical capacitor, which, during operation, affords the advantage that there is at least largely no electric field caused thereby in existence outside the capacitor. As an alternative or in addition, it has been found to be advantageous if use is made of a main body that has a surface made of polytetrafluoroethylene and/or a surface with a coefficient of static friction of μ<0.70, in particular a surface made of aluminum. A surface configuration of this nature makes it possible for the main body to be removed particularly easily before the layer system is sintered, such that, for example, a cylindrical main body may be pulled axially out of a correspondingly cylindrical layer system. In this respect, it may be provided that the main body consists entirely of a material that is as smooth as possible, for example, polytetrafluoroethylene or aluminum, or that merely the surface of the main body is provided with this smooth material by spraying or by applying a corresponding sheet or by coating with aluminum or the like.

In a further advantageous configuration, it is provided that the electrically conductive layers are produced in such a manner that they make contact with the main body alternately on opposing sides of the main body. In other words, it is provided that the electrically conductive layers are embodied in such a way that a first electrically conductive layer extends down to the main body on one side of the layer system, but on the opposing side of the layer system is kept at a distance from the surface of the main body or from the edge of the dielectric layer. The second electrically conductive layer, which follows the first electrically conductive layer, has a converse form, such that the metallization is kept at a distance from the edge of the underlying green sheet on one side of the layer system and on the other side of the layer system extends down to the main body. The same applies for all of the following electrically conductive layers. This forms a multi-ply capacitor in which the electrical contact surfaces lie on opposing sides of the layer system. Moreover, a comparatively thick electrically conductive layer is thereby formed on the main body, and this has an advantageous effect in terms of the current loading capacity of the capacitor.

In a further advantageous configuration, it is provided that the layer system is formed in a manner tapering radially outward proceeding from the main body. This may be achieved, for example, by varying the width of the green sheets, in order to provide an uninterrupted lateral metallization of the layer system.

Further advantages arise through the use of at least one green sheet that includes a low temperature cofired ceramic and/or a high temperature cofired ceramic and/or an alkali-free glass material. This allows for a particularly precise settability of the permittivity, of the specific capacitance, of the breakdown voltage and of the temperature resistance of the capacitor. If alkali-free glasses are used, it is advantageously possible to combine a high capacitance density with a high dielectric strength.

Further advantages arise in that, after sintering, the capacitor is integrated in a power cable and/or in a coaxial cable and/or in a resonant heating line. It is thereby possible to realize the specific advantages of the capacitor for different applications with high demands on the resistance of the capacitor to high voltages, currents and temperatures. If the capacitor is formed as a cylindrical capacitor, it may be integrated in a manner saving a particularly large amount of space in coaxial cables and/or resonant heating lines made up of alternating inductive and capacitive segments (e.g., for oil recovery).

A second aspect relates to a capacitor, in particular a cylindrical capacitor, including a layer system, which has at least two electrically conductive layers in each case galvanically isolated from one another by at least one dielectric layer made of at least one sintered green sheet. The advantages that arise therefrom may be gathered from the preceding descriptions of the first aspect, where advantageous configurations of the first aspect may be regarded as advantageous configurations of the second aspect, and vice versa. In this respect, it has been found to be advantageous if the capacitor is obtainable and/or obtained by a method according to one of the preceding exemplary embodiments.

Further advantages arise if the capacitor is formed with an at least substantially circular cross section and/or has a cylindrical cutout along a component axis. As a result, the capacitor may be integrated particularly easily in cylindrical components such as, for example, power cables, coaxial cables, and/or resonant heating lines. The cutout may also serve for the conduction of other lines, for example, for the transportation of current, electrical signals, or coolant.

A third aspect relates to the use of a capacitor according to one of the preceding exemplary embodiments for producing a power cable and/or a coaxial cable and/or a resonant heating line. The advantages that arise therefrom may be gathered from the preceding descriptions of the first and of the second aspect, where advantageous configurations of the first and of the second aspect may be regarded as advantageous configurations of the third aspect.

### BRIEF DESCRIPTION OF THE DRAWINGS

Further features of the invention become apparent from the claims, the exemplary embodiments and also on the basis of the drawings. The features and combinations of features mentioned above in the description and also the features and combinations of features mentioned hereinbelow in the exemplary embodiments may be used not only in the respectively specified combination, but also in other combinations, without departing from the scope of the invention.

FIG. 1 depicts a schematic perspective view of an embodiment of a main body having a surface made of PTFE.

FIG. 2 depicts a schematic perspective view of an embodiment of the main body, around which a green sheet is wound to produce a layer system.

FIG. 3 depicts a schematic perspective view of an embodiment of the main body having a dielectric layer produced from the green sheet.

FIG. 4 depicts a schematic perspective view of an embodiment of the main body, in which an electrically conductive layer has been applied to the dielectric layer.

FIG. 5 depicts a schematic lateral sectional view of a further embodiment of a main body.

FIG. 6 depicts a schematic lateral sectional view of the main body in FIG. 5 having a dielectric layer and an electrically conductive layer.

FIG. 7 depicts a schematic lateral sectional view of an embodiment of the main body having a layer system made up of two dielectric layers and two electrically conductive layers.

FIG. 8 depicts a schematic lateral sectional view of an embodiment of the main body having a layer system made up of three dielectric layers and three electrically conductive layers.

FIG. 9 depicts a schematic lateral sectional view of the layer system in FIG. 8, from which the main body has been removed.

FIG. 10 depicts a schematic lateral sectional view of an embodiment of the capacitor after the layer system has been sintered.

FIG. 11 depicts a schematic lateral sectional view of a cylindrical main body, to which a layer system made up of sixteen electrically conductive layers and fifteen dielectric layers have been applied.

### DETAILED DESCRIPTION

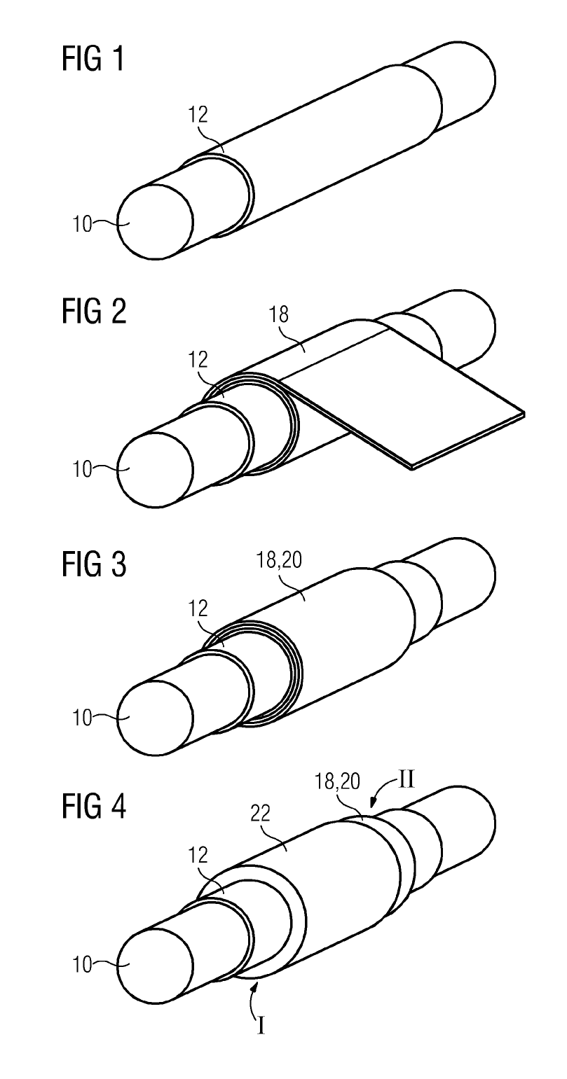

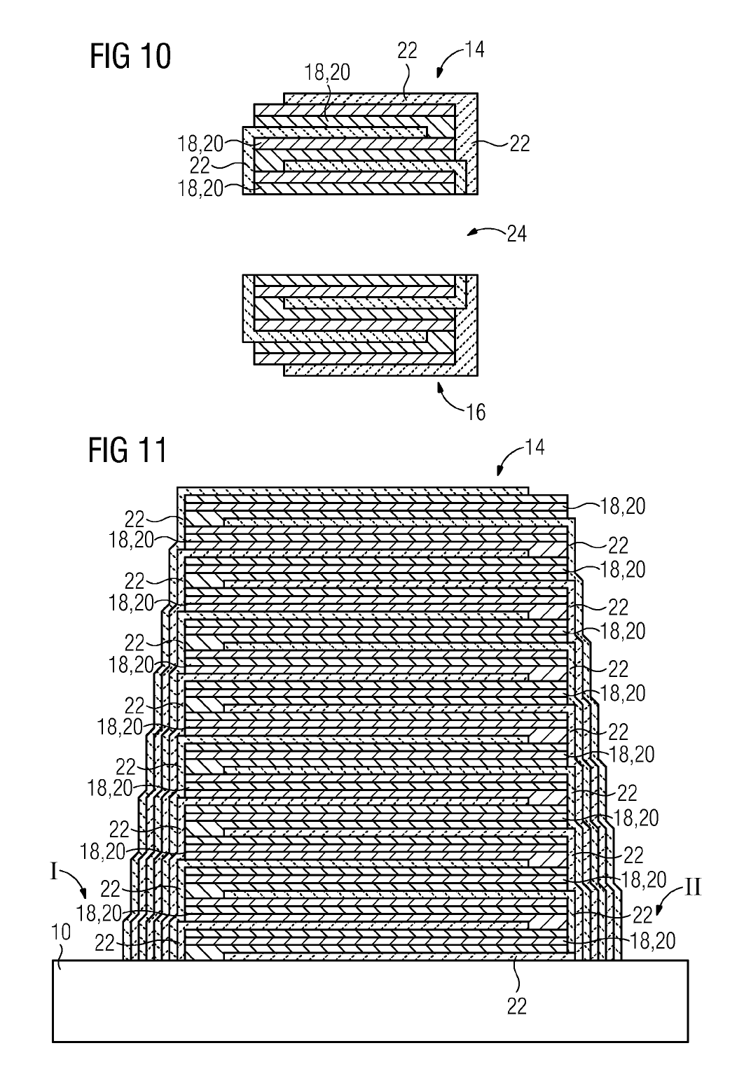

FIG. 1 depicts a schematic perspective view of a cylindrical main body 10 having a surface 12 made of polytetrafluoroethylene (PTFE, Teflon). The smooth surface 12 is formed in the present case as a coating and serves for pulling the main body 10 axially out of a layer system 14 after the layer system 14 has been produced (see FIG. 7), before the layer system is fired or sintered in a furnace to form the cylindrical capacitor 16 (see FIG. 10). The coated surface 12 may be produced, for example, by spraying the main body 10 with Teflon or by applying a Teflon sheet. Alternatively, it may be provided that the entire main body 10 consists of PTFE or a material with comparable sliding properties.

FIG. 2 depicts a schematic perspective view of the main body 10, around which a ceramic green sheet 18 is wound to produce the layer system 14 in a first act with a suitable mechanical stress, such that the green sheet 18 encloses the main body 10 on the outer circumference. One to ten plies of the green sheet 18 may be wound around the main body 10. The green sheet 18 may be commercially available or specially developed material, which, for example, has a sintering temperature of below 900° C. for LTCC (Low Temperature Cofired Ceramics) or a sintering temperature in the range of 1600-1800° C. for HTCC (High Temperature Cofired Ceramics). It may similarly be provided that the green sheet 18 may include alkali-free glass material or a glass-ceramic. Furthermore, it may be provided that a plurality of different green sheets 18 are applied to the main body 10.

FIG. 3 depicts a schematic perspective view of the main body 10 having a dielectric layer 20 that is produced from the green sheet 18 and which, after the layer system 14 has been sintered, represents the dielectric layers 20 of the finished capacitor 16. The green sheets 18 used are therefore to be chosen appropriately in terms of their dielectric properties.

After the first winding act, the dielectric layer 20 consisting of a plurality of plies of green sheet 18 is provided with an electrically conductive layer 22 using an organic paste containing metal particles such as, for example, silver particles. By way of example, the electrically conductive layer 22 may be produced by dipping or spraying. Furthermore, it may be provided that the electrically conductive layer 22 is produced in a plurality of coating acts, it also being possible to use different pastes, metal particles, or the like. The metallization is embodied in this case in such a way that it alternately extends down to the main body 10 serving as the winding substrate on one side I or II of the layers 20, 22, but on the opposing side I or II is kept at a distance from the surface 12 of the main body 10 or from the edge of the dielectric layer 20. FIG. 4, in this respect, depicts a schematic perspective view of the main body 10, in which a first electrically conductive layer 22 has been applied to the dielectric layer 20 in the manner described above, with the electrically conductive layer 22 being pulled down to the surface 12 of the main body 10 on the side I thereof, but being kept at a distance from the edge of the green sheets 18 or of the dielectric layer 20 on the other side II. In further winding acts, the same number of plies or, if required, also a different number of plies of dielectric green sheet 18 may be wound, these then being metalized in such a way that the metallization alternately is kept at a distance from the sheet edge on one side I or II and extends down to the winding substrate, e.g., down to the main body 10, on the other side I or II.

For further explanation, FIGS. 5 to 10 depict, by way of example, various acts during the production of a capacitor 16. FIG. 5 depicts a schematic lateral sectional view of a further cylindrical main body 10, the main body 10 in this example consisting of a homogeneous material such as, for example, PTFE or aluminum.

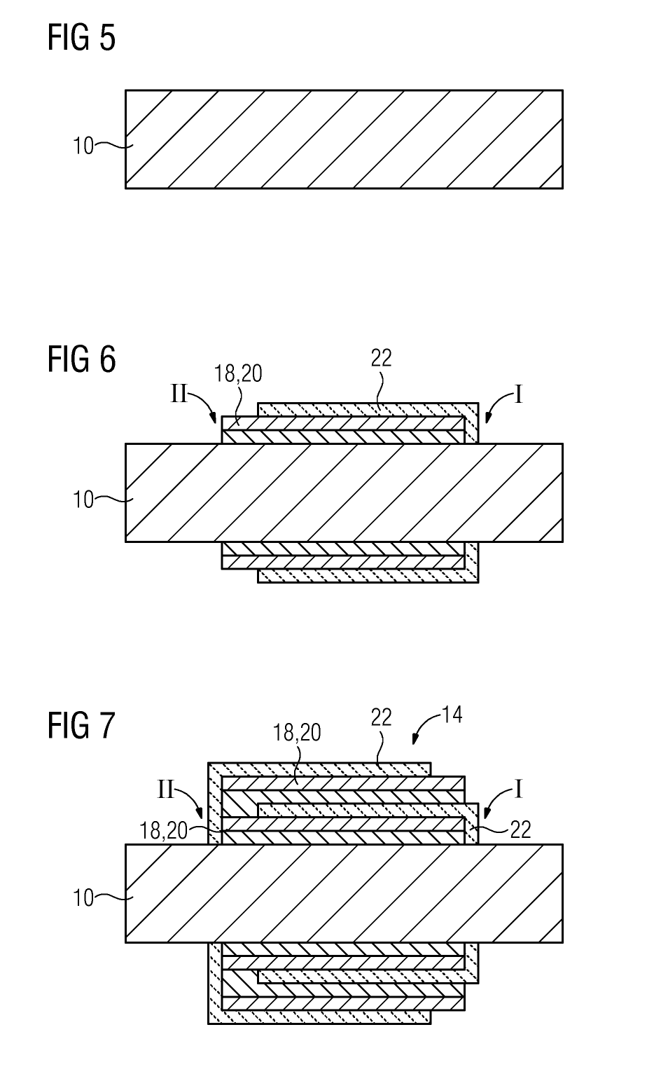

As may be seen in FIG. 6, the main body 10 is coated in succession in the manner described above with a dielectric layer 20 made up of, by way of example in number and orientation, two windings or plies of ceramic green sheet 18 and an electrically conductive layer 22. It may be seen that the electrically conductive layer 22 makes contact with the main body 10 only on the side I, but on the side II is kept at a distance from the edge of the dielectric layer 20.

FIG. 7 depicts a schematic lateral sectional view of the main body 10 having a layer system 14 that includes two dielectric layers 20 produced from corresponding windings of green sheets 18 and two electrically conductive layers 22. It may be seen that the electrically conductive layers 22 are pulled down onto the main body 10 alternately on the side I or II and are galvanically isolated from one another by the dielectric layers 20.

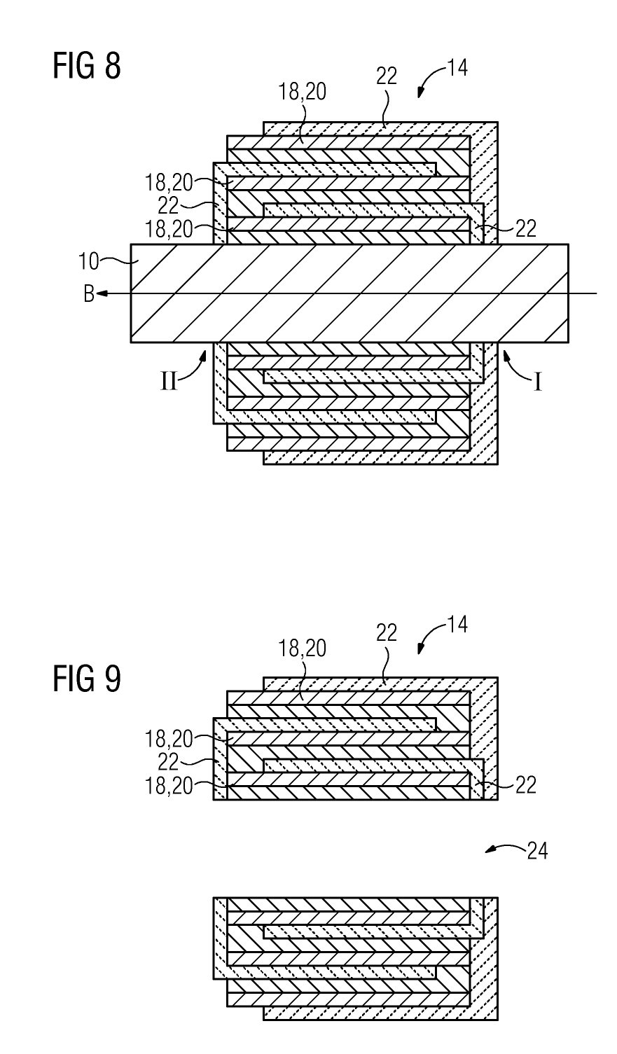

FIG. 8 depicts a schematic lateral sectional view of the main body 10 having a layer system 14 made up of three dielectric layers 18, 20 and three electrically conductive layers 22. Corresponding repetitions of winding and metallization acts thus give rise to a multi-ply layer system 14, in which the electrically conductive layers 20 serving as later contact surfaces of the capacitor 16 are contact-connected on the opposing sides I and II of the layer system 14.

FIG. 9 depicts a schematic lateral sectional view of the layer system 14, from which the main body 10 has been removed in the axial direction as per the component axis B of the layer system 14 depicted in FIG. 8 before the subsequent sintering. This creates a cylindrical cutout 24. The main body 10 may then be reused for a further method run. Depending on the configuration of the capacitor 16, it may also be provided that a main body 10 made of a thermally stable material is used and concomitantly sintered. Alternatively, use may be made of a main body 10 that decomposes during the sintering.

Depending on the green sheets 18 used, the layer system 14 is sintered to form the multi-ply capacitor 16 at approximately 900° C., for example, after the main body 10 has been removed. FIG. 10 in this respect depicts a schematic lateral sectional view of the capacitor 16 after the layer system 14 has been sintered. It may be seen that the volume of the finished capacitor 16 has decreased slightly as a result of the fact that the binder has been burnt out of the dielectric and electrically conductive layers 20, 22.

FIG. 11 depicts a cross section (not to scale) of a cylindrical main body 10, to which a further exemplary embodiment of a layer system 14 made up of sixteen electrically conductive layers 22 and fifteen dielectric layers 20 has been applied. It may be seen that, in contrast to the preceding exemplary embodiment, the layer system 14 has as the first layer an electrically conductive layer 22, to which a dielectric layer made up of three windings of green sheet 18 has been applied. Alternatively, the bottom and/or top electrically conductive layer 22 (e.g., electrode) may be omitted for reasons of radial inward and outward insulation. Since the metallization is pulled down to the main body either on the right or on the left, or on side II or on side I, after each winding act, a high paste thickness is formed in the vicinity of the main body 10. This has an advantageous effect in terms of the current loading capacity of the capacitor 16.

In a further embodiment of the capacitor 16, the width of the dielectric green sheets 18 may be reduced outward, that is to say with an increasing distance from the main body 10, in order to provide an uninterrupted lateral metallization of the layer system 14. The capacitance of the capacitor 16 is determined by the overlapping surface of the electrodes connected on the right and left on the circumference, e.g., by the length of the cylindrical main body, by the thickness of the dielectric layers 20, e.g., by the thickness of the dielectric green sheets 18, and the number of plies or windings. Furthermore, the capacitance is determined by the permittivity of the ceramic material of the green sheets 18 after sintering. The thickness of the dielectric similarly determines the electrical breakdown voltage of the capacitor 16, e.g., it represents the parameter with the aid of which the balance between capacitance and dielectric strength is set.

Breakdown voltages of 10 kV are achievable, for example, with commercially available glass-ceramic composite sheets (LTCC) with low sintering properties at thicknesses of 250 μm or with highly insulating (e.g., alkali-free) glass-based green sheets 18 having thicknesses of 30-50 μm. Characteristic values for specific capacitances and breakdown voltages of various exemplary embodiments of the capacitor 16 are indicated in table 1.

TABLE 1
Characteristic values for specific capacitances and breakdown voltages

| | | Thickness of the | | Thickness of the | | Thickness of the | |
|---|---|---|---|---|---|---|---|
| | | dielectric 250 μm | | dielectric 100 μm | | dielectric 30 μm | |
| | | | Break- | | Break- | | Break- |
| | | Specific | down | Specific | down | Specific | down |
| | | capacitance | voltage | capacitance | voltage | capacitance | voltage |
| Material | Permittivity | (pF/cm²) | (kV) | (pF/cm²) | (kV) | (pF/cm²) | (kV) |
| LTCC | 8 | 30 | 10 | 70 | 4 | 240 | 1 |
| Standard | | | | | | | |
| LTCC | 65 | 220 | 10 | 560 | 4 | 1900 | 1 |
| highly | | | | | | | |
| dielectric | | | | | | | |
| Alkali- | 5 | 16 | 6 | 40 | 5 | 140 | 12 |
| free glass | | | | | | | |

The capacitors 16 thus combine the following properties: (1) selection of material and geometrical dimensions achieves a high variability in terms of capacitance and breakdown voltage; (2) the use of alkali-free glasses makes it possible to combine a high capacitance density with a high dielectric strength; (3) a hollow cylindrical shape allows for integration in a manner saving space with axial cooling and in resonant heating lines made up of alternating inductive and capacitive segments (e.g., for oil recovery); (4) high temperature resistance; and (5) high dielectric strength.

The parameter values specified in the documents for defining process and measurement conditions for the characterization of specific properties of the subject matter of the invention are also to be regarded as encompassed by the scope of the invention in the context of deviations, for example, on account of measurement errors, system errors, weighing errors, DIN tolerances, and the like.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for producing a capacitor comprising:
providing a main body;
producing a layer system on the main body, the layer system comprising at least two electrically conductive layers, wherein each conductive layer is galvanically isolated from each additional conductive layer by at least one dielectric layer, the at least one dielectric layer being produced from at least one green sheet; and
sintering the layer system, therein providing the capacitor.

2. The method as claimed in claim 1, wherein: (1) the at least one dielectric layer is produced from at least two plies of the at least one green sheet, (2) the at least one green sheet is wound at least once around the main body to produce the at least one dielectric layer, or (3) the at least one dielectric layer is produced from the at least two plies of the at least one green sheet and the at least one green sheet is wound at least once around the main body.

3. The method as claimed in claim 1, wherein an organic paste comprising metal particles is used to produce the electrically conductive layers.

4. The method as claimed in claim 1, wherein the electrically conductive layers are produced with aid of a dipping process, a spraying process, or the dipping process and the spraying process.

5. The method as claimed in claim 1, further comprising:
removing the main body from the layer system before the layer system is sintered.

6. The method as claimed in claim 1, wherein the main body comprises a surface comprising: polytetrafluoroethylene or aluminum, a coefficient of static friction of μ<0.70, or both the polytetrafluoroethylene or the aluminum and the coefficient of static friction of μ<0.70.

7. The method as claimed in claim 1, wherein the electrically conductive layers make contact with the main body alternately on opposing sides of the main body.

8. The method as claimed in claim 1, wherein the layer system is formed in a manner tapering radially outward proceeding from the main body.

9. The method as claimed in claim 1, wherein the at least one green sheet comprises one or more of a low temperature cofired ceramic, a high temperature cofired ceramic, or an alkali-free glass material.

10. The method as claimed in claim 1, further comprising:
integrating the capacitor in a power cable, a coaxial cable, or a resonant heating line.

11. A capacitor comprising:
a layer system comprising at least two electrically conductive layers, wherein each conductive layer is galvanically isolated from each additional conductive layer by at least one dielectric layer made of at least one sintered green sheet.

12. The capacitor as claimed in claim 11, wherein the capacitor by providing a main body, producing the layer system on the main body, and sintering the layer system.

13. The capacitor as claimed in claim 11, wherein the capacitor comprises an at least substantially circular cross section, a cylindrical cutout along a component axis, or both the at least substantially circular cross section and the cylindrical cutout along the component axis.

14. The capacitor as claimed in claim 11, wherein the capacitor is configured to be used in one or more of the following: a power cable, a coaxial cable, or a resonant heating line.

15. The method as claimed in claim 5, further comprising:
integrating the capacitor in one or more of a power cable, a coaxial cable, or resonant heating line.

16. The method of claim 1, wherein the main body is a cylindrical main body.

17. The method of claim 6, wherein the main body is a cylindrical main body.

18. The capacitor of claim 11, wherein the capacitor is a cylindrical capacitor.
